(19) United States
(12) Patent Application Publication
(10) Pub. No.: US 2020/0130431 A1
(43) Pub. Date: Apr. 30, 2020

(54) PNEUMATIC TIRE WITH NOISE SUPPRESSING MEMBER, TIRE/RIM ASSEMBLY, AND NOISE SUPPRESSING MEMBER

(71) Applicant: BRIDGESTONE CORPORATION, Chuo-ku, Tokyo (JP)

(72) Inventors: Keiichi HASEGAWA, Chuo-ku, Tokyo (JP); Yoshifumi MATSUMOTO, Chuo-ku, Tokyo (JP); Yoshihide KOUNO, Chuo-ku, Tokyo (JP)

(21) Appl. No.: 16/623,763

(22) PCT Filed: Jun. 14, 2018
(86) PCT No.: PCT/JP2018/022801

§ 371 Date: Dec. 17, 2019

(30) Foreign Application Priority Data
Jun. 19, 2017 (JP) 2017-119691

(51) Int. Cl. B60C 19/00; B60C 9/20

(52) U.S. Cl. CPC B60C 19/002; B60C 9/20

(57) ABSTRACT

A pneumatic tire with a noise suppressing member has: a pneumatic tire that has a belt layer structured to include a steel cord; a noise suppressing member that is formed from a sheet-shaped member, and that has convex portions, which are convex from an inner surface side of a tire toward a cavity interior, in order to suppress cavity resonance of the pneumatic tire; and magnets that are attached to the noise suppressing member, and at which attractive force is generated between the magnets and the steel cord, and that holds the noise suppressing member at an inner surface of the tire.

### TECHNICAL FIELD

The present disclosure relates to a pneumatic tire with a noise suppressing member, a tire/rim assembly, and a noise suppressing member.

### BACKGROUND ART

A structure is disclosed in which a noise absorbing member that is formed from a sponge is disposed at a tire inner surface, and cavity resonance of a pneumatic tire is suppressed (refer to Japanese Patent Application Laid-Open (JP-A) No. 2011-093462).

### SUMMARY OF INVENTION

### Technical Problem

However, there are cases in which the application of a sponge to a pneumatic tire is difficult due to cost limitations.

An object of the present disclosure is to lower costs while suppressing cavity resonance of a pneumatic tire.

### Solution to Problem

A pneumatic tire with a noise suppressing member relating to a first aspect has a pneumatic tire including a tire structural member that is formed from a magnetic body; a noise suppressing member formed from a sheet-shaped member and the noise suppressing member having convex portions, which are convex from an inner surface side of the pneumatic tire toward a cavity interior, configured to suppress cavity resonance of the pneumatic tire; and magnets attached to the noise suppressing member, at which attractive force is generated between the magnets and the magnetic body, and the magnets holding the noise suppressing member at an inner surface of the pneumatic tire.

In the pneumatic tire with a noise suppressing member relating to the first aspect, the noise suppressing member is disposed at an inner portion of the pneumatic tire. At least a portion of the annular space that is formed at the inner portion of the pneumatic tire is in a state of being partitioned by the convex portions of the noise suppressing member, and the generation of cavity resonance can be impeded. The noise suppressing member can apply attractive force of the magnets to the tire structural member, which is formed from a magnetic body, of the pneumatic tire. Due thereto, the noise suppressing member can be held at the tire inner surface.

Because the noise suppressing member is molded as a sheet-shaped member, the total cost of the noise suppressing member, including the materials cost and the manufacturing cost, can be made to be lower than in a case in which a sponge is used. Moreover, there is no need for a special process such as the kneading-in of a magnetic body, or the coating of a magnet, or the like, and the noise suppressing member can be held at the tire inner surface by using magnets that are generally on the market. Therefore, a reduction in the cost of the noise suppressing member can be devised with regard to this point as well.

Moreover, the noise suppressing member is not stored while being held at the pneumatic tire, and the pneumatic tire and the noise suppressing member are stored separately, and the pneumatic tire can be made to hold the noise suppressing member at the time of mounting to a vehicle. Therefore, a deterioration in the noise suppressing member can be suppressed.

In a second aspect, in the pneumatic tire with a noise suppressing member relating to the first aspect, the tire structural member comprises a reinforcing layer that is formed from a steel cord.

In the pneumatic tire with a noise suppressing member relating to the second aspect, the tire structural member that is formed from the magnetic body a reinforcing layer that is formed from a steel cord. Accordingly, by using a pneumatic tire that has a reinforcing layer formed from a steel cord, the noise suppressing member can be easily mounted by using this reinforcing layer. In other words, there is no separate need for a magnetic body, which applies the attractive force of a magnet, to be used as a separate member.

Because the noise suppressing member can be held without subjecting the inner surface of the pneumatic tire to a treatment, the noise suppressing member can be easily retained not only at a pneumatic tire that is a new product, but also at a pneumatic tire that is existing or is in use. Further, the pneumatic tire can be made to hold the noise suppressing member not only at the manufacturer, but also at a store.

In a third aspect, in the pneumatic tire with a noise suppressing member relating to the first aspect or the second aspect, the reinforcing layer comprises a belt.

In the pneumatic tire with a noise suppressing member relating to the third aspect, the noise suppressing member can be easily mounted by using a belt that is formed from a steel cord. Further, because the belt is disposed at the tread portion of a pneumatic tire, when the pneumatic tire rotates and centrifugal force is applied to the noise suppressing member, the noise suppressing member is pushed against the surface that is at the reverse side of the tread portion. The noise suppressing member is pushed against the surface that is at the reverse side of the tread portion by the pushing force caused by the centrifugal force and by the attractive force caused by the magnets. Therefore, separating of the noise suppressing member from the inner surface of the pneumatic tire can be suppressed effectively.

In a fourth aspect, in the pneumatic tire with a noise suppressing member relating to any one of the first aspect through the third aspect, the tire structural member is provided at an inner peripheral surface of the pneumatic tire.

In the pneumatic tire with a noise suppressing member relating to the fourth aspect, the tire structural member that is formed from a magnetic body is provided at the inner peripheral surface of the pneumatic tire. Therefore, the tire structural member that is formed from a magnetic body can be made to directly hold the noise suppressing member, and a large attractive force can be applied as compared with a case in which for example, the attractive force of the magnets is applied to a magnetic body that is embedded in the tread interior.

A tire/rim assembly relating to a fifth aspect has a rim; and the pneumatic tire with a noise suppressing member relating to any one of the first aspect through the fourth aspect that is mounted at the rim.

The tire/rim assembly relating to the fifth aspect is structured by the rim, and the pneumatic tire with a noise suppressing member relating to any one of the first aspect through the fourth aspect that is mounted at the rim. Therefore, an annular space is formed between the pneumatic tire and the rim. However, because at least a portion of this space can be partitioned by the convex portions of the noise suppressing member, the generation of cavity resonance between the tire and the rim can be impeded. Further, the tire/rim assembly that can impede generation of cavity resonance can be obtained easily, and costs can be reduced as compared with a case in which a sponge is used.

A noise suppressing member relating to a sixth aspect has a noise suppressing member main body formed from a sheet-shaped member, that is configured to be disposed at an inner portion of a pneumatic tire, and that has convex portions, which are convex from an inner surface side toward a radial direction inner side of the pneumatic tire, configured to suppress cavity resonance of the pneumatic tire; and magnets provided at the noise suppressing member main body, and the magnets generating attractive force with respect to a magnetic body that is provided at the pneumatic tire.

The noise suppressing member relating to the sixth aspect can be easily held at the inner surface of a pneumatic tire that has a magnetic body, by using the attractive force of the magnets and without using an adhesive or the like. Further, because the noise suppressing member is formed from a sheet-shaped member, the total cost, including the materials cost and the manufacturing cost, can be made to be lower than with in a case in which a sponge is used.

### Advantageous Effects of Invention

In accordance with the pneumatic tire with a noise suppressing member, the tire/rim assembly, and the noise suppressing member relating to the present disclosure, the excellent effect is obtained that cavity resonance of a pneumatic tire can be suppressed at a lower cost than with a sponge.

### BRIEF DESCRIPTION OF DRAWINGS

FIG. 1A is a cross-sectional view showing a state in which a tire/rim assembly relating to an embodiment of the present invention is cut in a tire axial direction.

FIG. 1B is a cross-sectional view in which a portion of a tread is enlarged.

FIG. 2 is a perspective view showing a noise suppressing member.

FIG. 3A is a side view that schematically shows an example in which the noise suppressing member is disposed over the entire tire circumferential direction, at the tire/rim assembly relating to the present embodiment.

FIG. 3B is a side view that schematically shows an example in which the noise suppressing member is disposed discretely in the tire circumferential direction, at the tire/rim assembly relating to the present embodiment.

FIG. 4A is a perspective view showing a magnet mounting portion.

FIG. 4B is a perspective view in which the magnet mounting portion shown in FIG. 4A is in a cross-section.

FIG. 5 is a perspective view showing a noise suppressing member relating to another embodiment.

FIG. 6A is a perspective view showing a magnet mounting portion relating to another embodiment.

FIG. 6B is a perspective view in which the magnet mounting portion shown in FIG. 6A is in a cross-section.

FIG. 7 is a cross-sectional view showing a noise suppressing member relating to another embodiment.

### DESCRIPTION OF EMBODIMENTS

Embodiments of the present invention are described hereinafter on the basis of the drawings. In the drawings, the arrow C direction indicates the pneumatic tire circumferential direction, the arrow R direction indicates the pneumatic tire radial direction, and arrow W indicates the pneumatic tire width direction. The pneumatic tire radial direction means the direction orthogonal to the pneumatic tire rotation axis (not illustrated). The pneumatic tire width direction means the direction parallel to the tire rotation axis. The pneumatic tire width direction can also be called the pneumatic tire axial direction. The methods of measuring the dimensions of the respective portions are methods described in the 2017 YEAR BOOK issued by JATMA (Japan Automobile Tyre Manufacturer Association, Inc.).

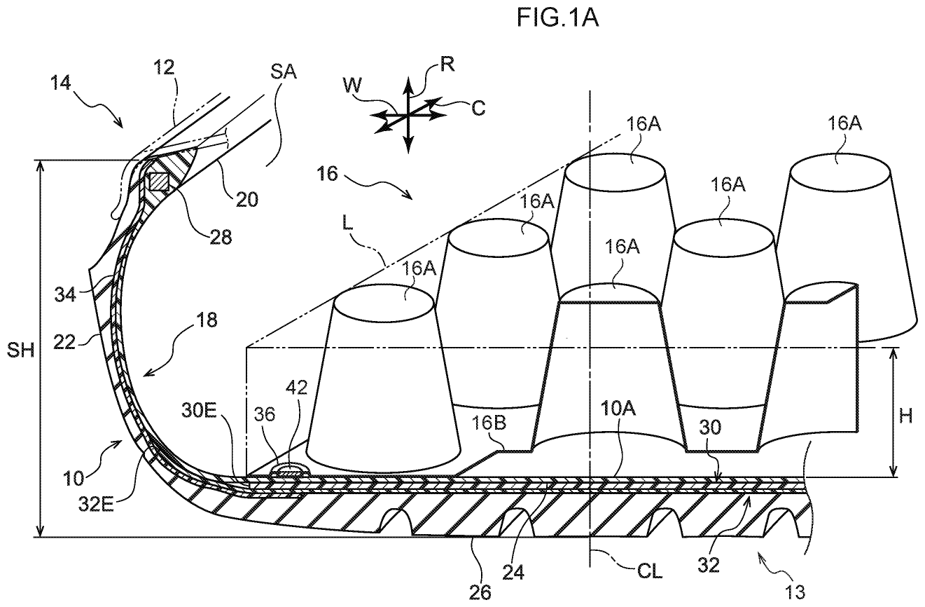

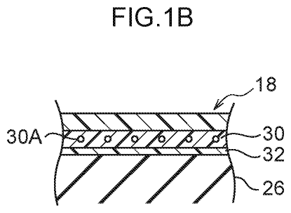

In FIG. 1, a tire/rim assembly 14 is structured to include a pneumatic tire 10, a rim 12 to which the pneumatic tire 10 is mounted, and a noise suppressing member 16 that is disposed at an inner portion of the pneumatic tire 10. Further, in the present embodiment, the pneumatic tire 10 at whose inner portion the noise suppressing member 16 is held is called a pneumatic tire 13 with a noise suppressing member.

The noise suppressing member 16 that is for suppressing cavity resonance is disposed at a tire inner surface 10A that is a reverse surface side of the tread of the pneumatic tire 10. Due thereto, at least a portion of annular space SA that is formed in the pneumatic tire 10 is in a state of being partitioned by the noise suppressing member 16. The noise suppressing member 16 is not a member for absorbing cavity resonance that arises temporarily, and is a member for making it such that cavity resonance itself is not generated.

(Tire Frame Member)

A tire frame member 18 is structured from a resin material for example. Concretely, the tire frame member 18 is formed in an annular shape in the tire circumferential direction due to a pair of tire pieces (not illustrated) that are formed of resin materials being joined in the tire axial direction at a tire equatorial plane CL. Note that the tire frame member 18 may be formed by three or more tire pieces being joined together.

Further, the tire frame member 18 has a pair of bead portions 20, a pair of side portions 22 that respectively extend toward a tire radial direction outer side from the pair of bead portions 20, and a crown portion 24 that extends toward a tire width direction inner side from the side portions 22.

Note that, at the tire frame member 18 of the present embodiment, portions, which are up to 30% of sectional height SH of the tire from tire radial direction inner side ends, are called the bead portions 20. A portion at which a tread 26 is disposed is called the crown portion 24.

A thermoplastic resin, a thermoplastic elastomer (TPE), a thermosetting resin, or the like that has elasticity that is equivalent to that of rubber can be used as the resin material that structures the tire frame member 18. In consideration of the elasticity at the time of traveling and the moldability at the time of manufacturing, it is preferable to use a thermoplastic elastomer. Note that the entire tire frame member 18 may be formed of the above-described resin material, or a portion thereof only may be formed of the above-described resin material.

Examples of thermoplastic elastomers are polyolefin thermoplastic elastomers (TPO), polystyrene thermoplastic elastomers (TPS), polyamide thermoplastic elastomers (TPA), polyurethane thermoplastic elastomers (TPU), polyester thermoplastic elastomers (TPC), dynamically cross-linked thermoplastic elastomers (TPV), and the like.

Examples of thermoplastic resins are polyurethane resins, polyolefin resins, vinyl chloride resins, polyamide resins and the like. Moreover, for example, resins whose deflection temperature under load prescribed by ISO 75-2 or ASTM D648 (at the time of a load of 0.45 MPa) is greater than or equal to 78° C., whose tensile yield strength prescribed by JIS K7113 is 10 MPa or more, whose tensile break elongation prescribed by that same JIS K7113 is 50% or more, and whose Vicat softening temperature (A method) prescribed by JIS K7206 is 130° C. or more can be used as the thermoplastic resin.

Bead cores 28 are embedded in the bead portions of the tire frame member 18. Metal, organic fibers, structures in which organic fibers are covered by resin, or hard resins or the like can be used as the material that structures the bead cores 28. Note that the bead cores 28 may be omitted provided that the rigidity of the bead portions 20 is ensured and problems do not arise in fitting to the rim 12.

(Belt Layer)

A belt layer 30 that serves as an example of a tire structural member is provided at an outer peripheral surface of the crown portion 24. The belt layer 30 is structured by, for example, a steel cord 30A (see FIG. 1B), which serves as a magnetic body and that is covered by a resin, being wound in a spiral form in the tire circumferential direction.

(Belt Reinforcing Layer)

A belt reinforcing layer 32 that covers the belt layer 30 is disposed at a tire radial direction outer side of the belt layer 30. The belt reinforcing layer 32 extends from the tire equatorial plane CL side over end portions 30E of the belt layer 30 to tire width direction outer sides, and finally ends in vicinities of the borders between the side portions 22 and the crown portion 24.

The belt reinforcing layer 32 has plural reinforcing cords (not illustrated) that are covered by rubber. The reinforcing cords of the belt reinforcing layer 32 are mono-filaments (single wires) of organic fibers or multi-filaments (intertwined wires) in which organic fibers are intertwined, and extend in the tire width direction and are lined-up in the tire circumferential direction. Note that the reinforcing cords of the belt reinforcing layer 32 may be inclined at an angle of 10° or less with respect to the tire width direction.

A material such as an aliphatic polyamide, PET (polyethylene terephthalate), glass, aramid, or the like can be used as the organic fibers. Note that a metal such as steel or the like that serves as the magnetic body may be used as the material of the reinforcing cords. Further, at the belt reinforcing layer 32, the reinforcing cords may be covered by resin and not rubber.

(Side Reinforcing Layers)

Side reinforcing layers 34 are disposed at tire outer surface sides of the tire frame member 18. The side reinforcing layers 34 extend along an outer surface of the tire frame member 18 from tire radial direction inner sides toward tire radial direction outer sides of the bead cores 28. The side reinforcing layers 34 further extend along an outer surface of the belt reinforcing layer 32 toward a tire equatorial plane CL side, and cross-over end portions 32E of the belt reinforcing layer 32 and the end portions 30E of the belt layer 30, and finally end in vicinities of the end portions 30E.

The side reinforcing layers 34 have plural reinforcing cords that are covered by rubber. The reinforcing cords of the side reinforcing layers 34 are mono-filaments (single wires) of organic fibers or multi-filaments (intertwined wires) in which organic fibers are intertwined, and extend in the radial direction (the tire radial direction) and are lined-up in the tire circumferential direction. Note that the reinforcing cords of the side reinforcing layers 34 may be inclined at an angle of 10° or less with respect to the tire radial direction.

A material such as an aliphatic polyamide, PET, glass, aramid, or the like can be used as the organic fibers. Note that a metal such as steel or the like that serves as the magnetic body may be used as the material of the reinforcing cords. Further, at the side reinforcing layers 34, the reinforcing cords may be covered by resin and not rubber.

(Noise Suppressing Member)

The noise suppressing member 16 is a member for suppressing cavity resonance, and is formed from a sheet-like resin for example. The noise suppressing member 16 can also be called a cavity resonance noise suppressing member, a silencing member, a partitioning member or the like. The resin that structures the noise suppressing member 16 is a thermoplastic resin for example. The noise suppressing member 16 can be manufactured more easily and at a lower cost than with a case in which a sponge is used, by using a publicly known molding method such as vacuum molding, pressure molding, blow molding, press molding or the like. For example, polyvinyl chloride resin (PVC), PET resin or the like that are flexible can be used as the thermoplastic resin that structures the noise suppressing member 16, and other thermoplastic resins can also be used. Note that, other than a thermoplastic resin, the resin that structures the noise suppressing member 16 may be a thermosetting resin or the like for example.

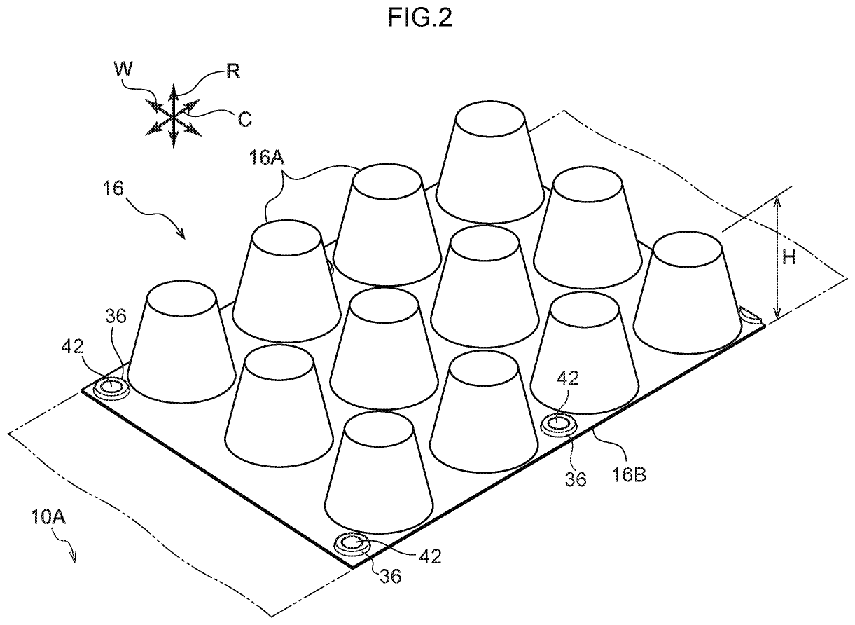

As shown in FIG. 1A and FIG. 2, the noise suppressing member 16 has a base portion 16B that is made to contact the tire inner surface 10A. As an example, at the time of molding the noise suppressing member 16, as shown in FIG. 2, the base portion 16B is made to be a planar shape, and, at the time of placing the noise suppressing member 16 at the inner portion of the pneumatic tire 10, the base portion 16B is curved. Because the base portion 16B is a sheet-shaped resin, it can be curved easily.

It is preferable to set a width of the base portion 16B to be equal to a width of the belt layer 30. This is because, if the base portion 16B is in the range at which the belt layer 30 is formed, the tire deformation is small, and therefore, the durability of the base portion 16B improves. Plural convex portions 16A that are formed in the shapes of truncated cones are formed at the base portion 16B in the form of a matrix at intervals in the tire circumferential direction and the tire width direction. Note that tire radial direction outer side surfaces of the convex portions 16A are concave. Note that the convex portions 16A can also be called projecting portions, jutting portions, or the like.

As shown in FIG. 1A and FIG. 2, maximum height dimension H (see FIG. 1A and FIG. 2) of the convex portions 16A of the noise suppressing member 16 that is measured along the tire radial direction is preferably greater than or equal to 50% of the tire sectional height SH. The maximum height dimension H is the height in the state in which the noise suppressing member 16 is made to contact the tire inner surface. This is because, if the maximum height dimension H is less than 0.5 SH, the effect of suppressing cavity resonance is lessened.

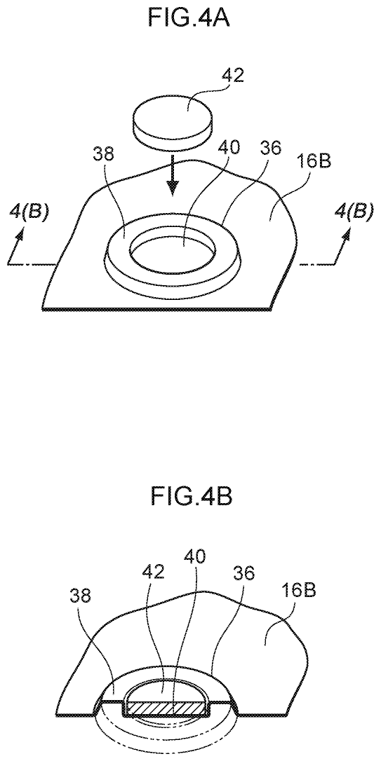

As shown in FIG. 1A and FIG. 4A, plural magnet mounting portions 36 are formed in vicinities of the both ends in the width direction of the base portion 16B, at intervals along the tire circumferential direction. The magnet mounting portions 36 have convex portions 38, which are annular and project-out toward the tire radial direction inner side, i.e., the side opposite the tire inner surface. Disc-shaped magnets 42 are fit into concave portions 40, which are at the inner sides of the convex portions 38, and are fixed by an adhesive or the like. Rare-earth magnets whose magnetic forces are large, such as neodymium magnets, samarium cobalt magnets and the like are preferably used as the magnets 42, and generic products that are generally on the market can be used therefor.

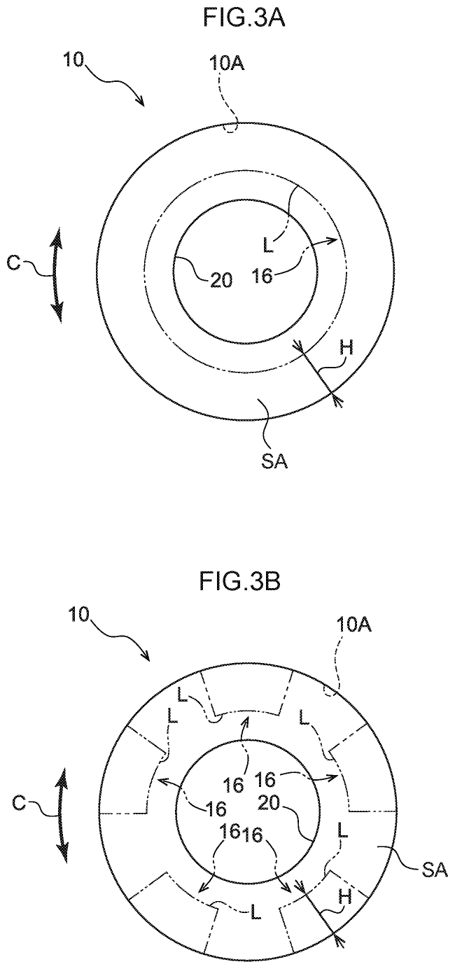

As shown in FIG. 3A, the noise suppressing member 16 may be disposed over the entire tire circumferential direction, or, as shown in FIG. 3B, the noise suppressing member 16 may be disposed discretely in the tire circumferential direction. In the case of discrete placement, it is desirable for a prime number of the noise suppressing members 16 to be disposed non-uniformly in the tire circumferential direction in consideration of the uniformity of the pneumatic tire 10 and the like.

(Operation)

The present embodiment is structured as described above, and operation thereof is described hereinafter. In FIG. 1A, at the pneumatic tire 10 relating to the present embodiment, the noise suppressing member 16 that has the convex portions 16A is held at the tire inner surface 10A by the attractive forces (in other words, the magnetic forces) of the magnets 42. Namely, because the belt layer 30 of the pneumatic tire 10 is structured by the resin-covered steel cord being wound in a spiral form in the tire circumferential direction, when the noise suppressing member 16 is placed at the tire inner surface 10A that is at the reverse surface side of the tread, attractive forces arise between the steel cord 30A and the magnets 42 that are attached to the base portion 16B, and the noise suppressing member 16 is pushed against and held at the tire inner surface 10A. Note that, at the time when the pneumatic tire 10 is rotating, centrifugal force acts on the noise suppressing member 16, and the noise suppressing member 16 is pushed against the tire inner peripheral surface.

Because the noise suppressing member 16 is not retained at the tire inner surface 10A by using an adhesive or the like, it is easy for the noise suppressing member 16 to be held at the tire inner surface 10A, and removal thereof is also easy.

Further, the noise suppressing member 16 can easily be held if the tire is a pneumatic tire in which a magnetic body such as a steel cord or the like is contained as a tire structural member within the tread, and there is no need to separately ready a special magnetic body for holding the noise suppressing member 16 at the tire and to mount the noise suppressing member 16 to the tire. Accordingly, the noise suppressing member 16 can be easily retained even at existing, general pneumatic tires in which a magnetic body such as a steel cord or the like is contained as a tire structural member. Accordingly, it is easy to make the pneumatic tire 10 hold the noise suppressing member 16 not only at the tire manufacturer, but also at a tire store or the like. Further, the noise suppressing member 16 can be retained not only at the pneumatic tire 10 that is a new product, but also at the pneumatic tire 10 that is in use by being attached thereto later.

In the tire/rim assembly 14, the annular space SA is formed between the pneumatic tire 10 and the rim 12. At least a portion of the space SA is in a state of being partitioned in the tire circumferential direction by the convex portions 16A of the noise suppressing member 16. Due thereto, the generation of cavity resonance within the pneumatic tire 10 can be impeded. In other words, it can be made such that an acoustic space that generates cavity resonance is not formed within the pneumatic tire 10.

Because the noise suppressing member 16 is structured from a sheet-shaped member of resin, the materials cost can be made to be lower than in a case in which a sponge is used. Moreover, molding and mounting are easy, and a lowering of costs is possible. Accordingly, in accordance with the pneumatic tire 10 relating to the present embodiment, cavity resonance can be suppressed at a lower cost than in a case in which a sponge is used.

Further, generic products that are on the market can be used for the magnets 42 that are for retaining the noise suppressing member 16, and the noise suppressing member 16 can be provided at a low cost.

Moreover, in the present embodiment, because the maximum height dimension H of the noise suppressing member 16 is set to greater than or equal to 50% of the tire sectional height SH, a good cavity resonance suppressing effect is obtained.

### OTHER EMBODIMENTS

An example of an embodiment of the present invention has been described above. However, embodiments of the present invention are not limited to the above, and the present invention can of course be implemented by being modified in various ways other than the above without departing from the scope of the present invention.

Although the tire frame member of the pneumatic tire 10 is structured by a resin material, the pneumatic tire 10 may be a rubber tire that uses carcass plies (not illustrated). In this case, the inner liner of the tire inner surface 10A is preferably made to be a thin film inner liner that is made of a publicly known synthetic resin. A film inner liner that is made of a synthetic resin can be formed to be thinner than an inner liner that is made of rubber. Due thereto, the steel cord 30A and the magnets 42 can be set close to one another, and the attractive force can be ensured.

The structure of the noise suppressing member 16 is not limited to the above-described structure. The shape of the convex portions 16A is not limited to a truncated cone shape, and may be another shape provided that cavity resonance can be suppressed, and the respective heights thereof may be different.

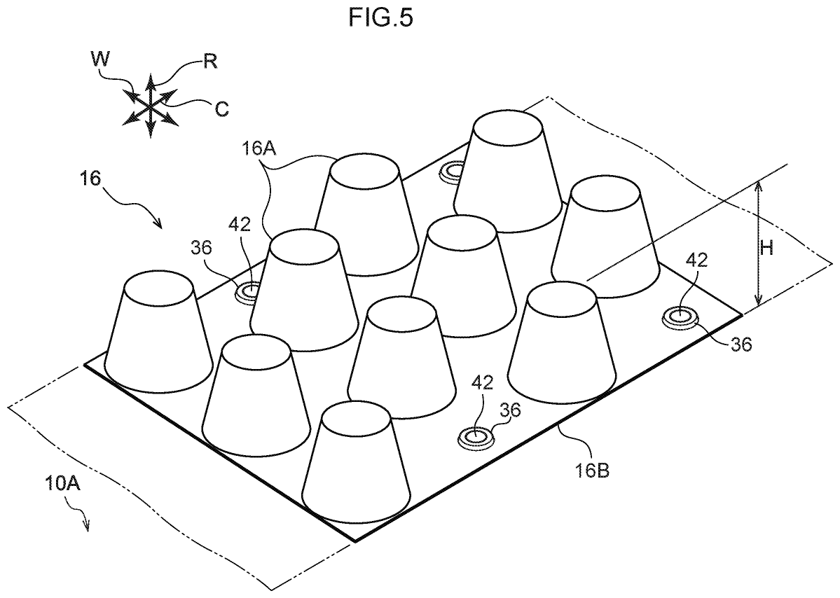

The arrangement of the convex portions 16A is not limited to that of the above-described embodiment. As shown in FIG. 5, the plural convex portions 16A may be disposed in a staggered form. Or, although not illustrated, the plural convex portions 16A may be disposed randomly.

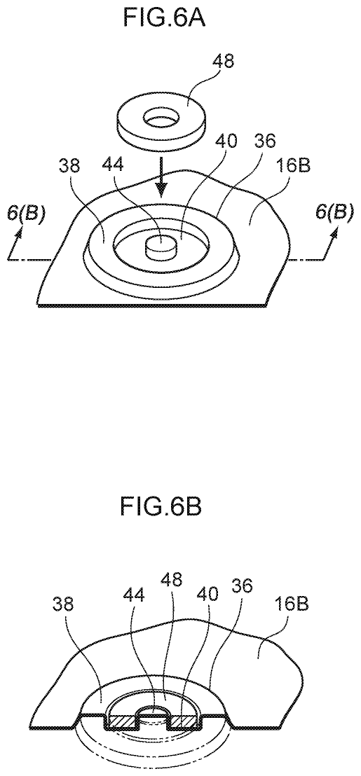

In the above-described embodiment, the magnet mounting portions 36 have the convex portions 38 that are annular, and the magnets 42 that are disc-shaped are fit with and adhered to the concave portions 40 that are at the inner sides of the convex portions 38. However, as shown in FIG. 6, convex portions 44 that are round may be formed at the centers of the concave portions 40 that are at the inner sides of the annular convex portions 38, and magnets 46 that are donut-shaped may be fit and adhered between the annular convex portions 38 and the circular convex portions 44. Further, although not illustrated, the shapes of the magnet mounting portions 36, the magnets 42 and the magnets 46 may be rectangular or the like.

At the convex portions 16A of the above-described embodiment, holes that pass in-and-out through the convex portions 16A are not formed, but holes that pass in-and-out through the convex portions 16A may be formed.

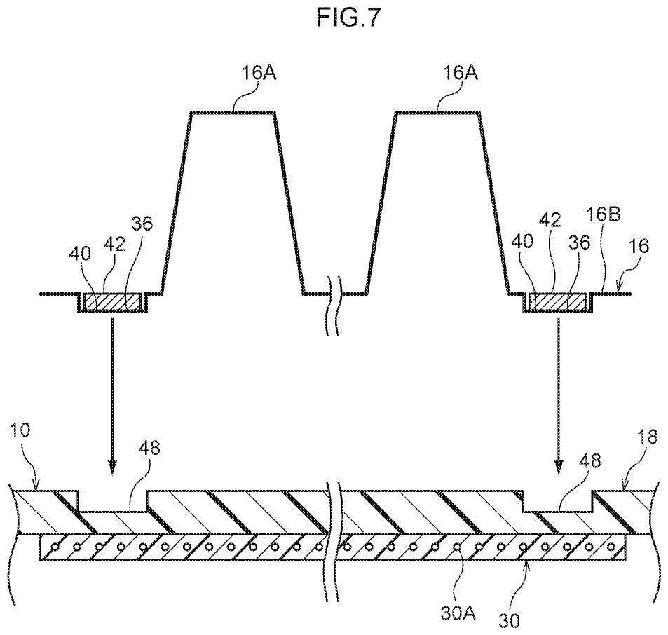

At the noise suppressing member 16 relating to another embodiment that is shown in FIG. 7, the magnets 42 that are disc-shaped are fit into the concave portions 40 that are formed in the base portion 16B, and are fixed by an adhesive or the like. Convex portions that are at sides opposite the concave portions 40 are fit-into concave portions 48 that are formed in the inner peripheral surface of the tire frame member 18. Due thereto, the magnets 42 are close to the steel cord 30A, and the attractive force can be increased. Further, because the convex portions that are at the sides opposite the concave portions 40 are fit into the concave portions 48 of the tire frame member 18, shifting of the noise suppressing member 16 also can be suppressed. Instead of the concave portions 48, portions of the tire frame member 18 may be formed to be thin.

In the pneumatic tire 10 of the above-described embodiment, the magnetic body is the steel cord that structures the belt layer 30. However, the magnetic body is not limited to the steel cord that structures the belt layer 30, and may be the steel belt of a reinforcing layer that is different from the belt layer 30 (as an example, the reinforcing cords of the belt reinforcing layer of the above-described embodiment may be made to be steel cords).

The magnetic body may be a tire structural member other than a steel cord, provided that attractive force is generated between the magnetic body and the magnet 42 or the magnet 46. For example, a thin steel plate, or a resin layer that is shaped as a thin sheet and into which is kneaded a powder of a strong magnetic body such as iron powder or the like, may be affixed to the inner peripheral surface of the pneumatic tire 10. Or, a powder of a strong magnetic body such as iron powder or the like may be kneaded into the tire frame member 18. Or, at the time of molding the tire frame member 18, the tire frame member 18 may be molded together with a resin sheet or a resin material that contains a strong magnetic body such as iron powder or the like. Further, magnetization may be carried out on these steel plates and powders of a strong magnetic body.

The disclosure of Japanese Patent Application No. 2017-119691 filed on Jun. 19, 2017 is, in its entirety, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

1. A pneumatic tire with a noise suppressing member, the pneumatic tire comprising:
a pneumatic tire including a tire structural member that is formed from a magnetic body;
a noise suppressing member formed from a sheet-shaped member, and having convex portions, which are convex from an inner surface side of the pneumatic tire toward a cavity interior, configured to suppress cavity resonance of the pneumatic tire; and
magnets attached to the noise suppressing member, and at which attractive force is generated between the magnets and the magnetic body, the magnets holding the noise suppressing member at an inner surface of the pneumatic tire.

2. The pneumatic tire with a noise suppressing member of claim 1, wherein the tire structural member comprises a reinforcing layer that is formed from a steel cord.

3. The pneumatic tire with a noise suppressing member of claim 2, wherein the reinforcing layer comprises a belt.

4. The pneumatic tire with a noise suppressing member of claim 1, wherein the tire structural member is provided at an inner peripheral surface of the pneumatic tire.

5. A tire/rim assembly, comprising:
a rim; and
the pneumatic tire with a noise suppressing member of claim 1, which is mounted at the rim.

6. A noise suppressing member, comprising:
a noise suppressing member main body formed from a sheet-shaped member, that is configured to be disposed at an inner portion of a pneumatic tire, and that has convex portions, which are convex from an inner surface side of the pneumatic tire toward an inner side in a tire radial direction, configured to suppress cavity resonance of the pneumatic tire; and
magnets provided at the noise suppressing member main body, the magnets generating attractive force with respect to a magnetic body provided at the pneumatic tire.

7. The pneumatic tire with a noise suppressing member of claim 2, wherein the tire structural member is provided at an inner peripheral surface of the pneumatic tire.

8. The pneumatic tire with a noise suppressing member of claim 3, wherein the tire structural member is provided at an inner peripheral surface of the pneumatic tire.

9. A tire/rim assembly, comprising:
a rim; and
the pneumatic tire with a noise suppressing member of claim 2, which is mounted at the rim.

10. A tire/rim assembly, comprising:
a rim; and
the pneumatic tire with a noise suppressing member of claim 3, which is mounted at the rim.

11. A tire/rim assembly, comprising:
a rim; and
the pneumatic tire with a noise suppressing member of claim 4, which is mounted at the rim.
